(19) United States
(12) Patent Application Publication
(10) Pub. No.: US 2026/0276590 A1
(43) Pub. Date: Sep. 17, 2026

(54) ROW-COLUMN ADDRESSED 2D EDDY CURRENT ARRAY

(71) Applicant: Evident Canada, Inc., Québec (CA)

(72) Inventor: Benoit Lepage, L’Ancienne-Lorette (CA)

(21) Appl. No.: 19/167,998

(22) PCT Filed: Mar. 28, 2024
(86) PCT No.: PCT/CA2024/050399

§ 371 Date: Sep. 23, 2025

Related U.S. Application Data
(60) Provisional application No. 63/493,392, filed on Mar. 31, 2023.

(51) Int. Cl. G01N 27/90; G01N 27/904

(52) U.S. Cl. CPC G01N 27/9006; G01N 27/904

(57) ABSTRACT

Row-column addressing techniques can be applied to eddy current (EC) coil elements to reduce the number of multiplexers in a two-dimensional EC probe. Individual coil elements can then be controlled to provide more robust EC inspection capabilities. Leakage current issues can be addressed by using diodes and biasing techniques.

### CLAIM OF PRIORITY

This patent application claims the benefit of priority U.S. Provisional Patent Application Ser. No. 63/493,392, titled “ROW-COLUMN ADDRESSED (RCA) 2D EDDY CURRENT ARRAY (ECA),” filed on Mar. 31, 2023, which is hereby incorporated by reference herein in its entirety.

### TECHNICAL FIELD

This document pertains generally, but not by way of limitation, to apparatus and techniques for non-destructive inspection such as facilitating eddy current inspection, and more particularly, to apparatus and techniques comprising an eddy current array (ECA) sensor assembly having respective sensor elements that are row-column addressed.

### BACKGROUND

Non-destructive testing (NDT) can refer to use of one or more different techniques to inspect regions on or within an object, such as to ascertain whether flaws or defects exist, or to otherwise characterize the object being inspected. One class of non-destructive testing can include use of an eddy current testing approach where electromagnetic energy is applied to the object and resulting induced currents on or within the object are detected, with the values of a detected current (or a related impedance) providing an indication of the structure of the object under test, such as to indicate a presence of a crack, void, porosity, or other inhomogeneity. Generally, an eddy current (EC) sensor includes one or more sensor elements such as inductive coils that can be excited using an alternating current (AC) source. Such coils (or other electromagnetic sensing elements such as hall sensors) can be used for receiving a signal indicative of an induced eddy current on or within the structure.

### SUMMARY

Examples described herein relate to a row-column addressed (RCA) eddy current array (ECA) probe. The RCA ECA probe comprising at least one coil array including a plurality of coil elements, a diode array including a plurality of diodes coupled to the plurality of coil elements, and a multiplexer assembly for row and column addressing of the plurality of coil elements.

Examples described herein also relate to a method comprising: activating a first set of coil elements in a row-column addressed (RCA) eddy current array (ECA) using a drive signal and a bias signal, wherein the bias signal operating at least one diode coupled to the first set of coil elements in a forward region; and receiving an electrical representation of an induced eddy current using the RCA ECA.

Examples described herein further relate to a probe assembly for eddy current testing. The probe assembly comprising a first layer of a printed circuit board including a first set of metallic traces for interleaved coil elements of a first coil array and a second coil array, a second layer of the printed circuit board including a second set of metallic traces for the interleaved coil elements of the first coil array and the second coil array, and a diode array coupled to the interleaved coil elements of the first coil array and the second coil array.

### BRIEF DESCRIPTION OF THE DRAWINGS

The subject matter herein may be better understood by referring to the following description in conjunction with the accompanying drawings. The drawings are not meant to limit the scope of the claims included herewith. For clarity, not every element may be labeled in every figure. The drawings are not necessarily to scale, emphasis instead being placed upon illustrating examples, principles, and concepts. Thus, features and advantages of the present disclosure will become more apparent from the following detailed description of examples thereof taken in conjunction with the accompanying drawings in which:

FIG. 1 shows example portions of a Row-Column Addressed (RCA) Eddy Current Array (ECA) probe;

FIG. 2 shows an example of an interleaved RCA ECA probe;

FIG. 3 shows an example of a multi-input RCA ECA probe;

FIG. 4A shows a first PCB layer with coil elements from two coil arrays;

FIG. 4B shows a second PCB layer with coil elements from the two coil arrays;

FIG. 4C shows a two-layer PCB stack;

FIG. 5 shows example portions of a RCE ECA probe;

FIG. 6 shows example portions of coil arrays in a single resolution sensor;

FIG. 7 shows example portions of coil arrays in a double resolution sensor; and

FIG. 8 shows example portions of array addressing of a double resolution sensor.

### DETAILED DESCRIPTION

Conventional eddy current (EC) systems are typically limited to one dimension. For example, a conventional EC probe with sixteen transmit coils and sixteen receive coils would be operated with two 16:1 multiplexers and associated drive and reception amplifier circuitry. To make a two-dimensional EC probe would then require thirty-two 16:1 multiplexers, which can be cost and space prohibitive.

As described in further detail below, row-column addressing techniques can be applied to EC coil elements to reduce the number of multiplexers in a two-dimensional EC probe. Individual coil elements can then be controlled to provide more robust EC inspection capabilities. Leakage current issues can be addressed by using diodes and biasing techniques described in further detail below.

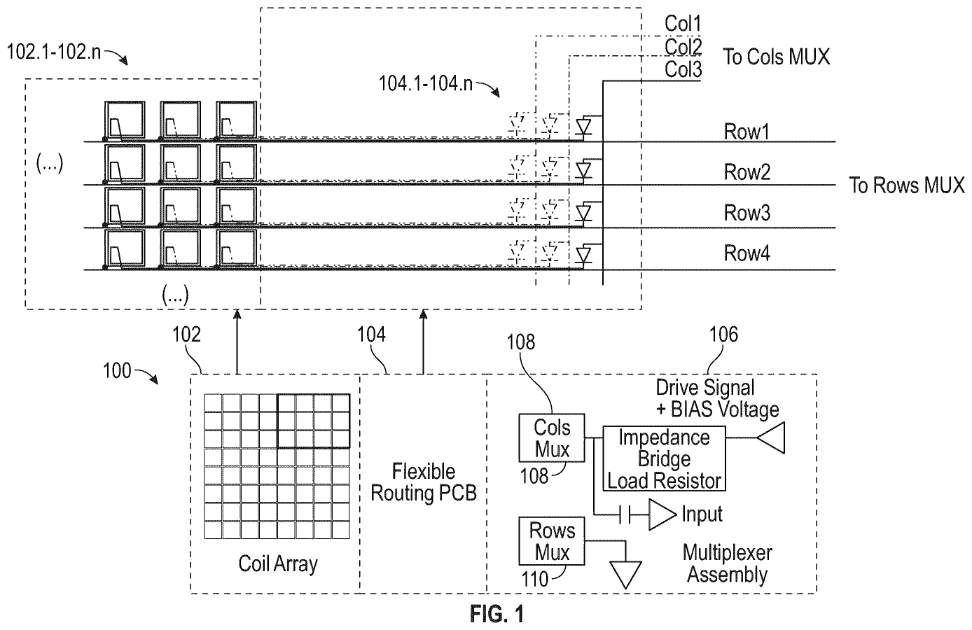

FIG. 1 shows example portions of a Row-Column Addressed (RCA) Eddy Current Array (ECA) probe 100. The RCA ECA probe 100 includes a coil array 102 including a plurality of coil elements 102.1-102.n, a flexible routing printed circuit board (PCB) 104 including a plurality of diodes 104.1-104.n, and a multiplexer assembly 106. FIG. 1 shows a simplified block diagram and a circuit schematic of the RCA ECA probe 100.

The coil array 102 may include metallization layers, such as traces, and is configured to be used in EC testing. For example, coil array 102 may be excited to generate electromagnetic energy for transmission into a test object, and the coil array 102 can receive a resulting EC signal induced in the test object. For example, the EC signal can be used for detecting different types of defects in the test object.

The coil array 102 includes a plurality of coil elements 102.1-102.n. In RCA systems, current can leak from one coil to another, which can also be referred to as cross talk. The coil array 102 can be coupled to a plurality of diodes 104.1-104.n provided in the flexible routing PCB 104 to reduce (or eliminate) leakage current between coils. As shown in FIG. 1, a respective diode of the plurality of diodes 104.1-104.n is provided for a corresponding coil of the plurality of coil elements 102.1-102.n. The plurality of diodes 104.1-104.n can be provided in series with their respective coil elements 102.1-102.n. The plurality of diodes 104.1-104.n are provided on the flexible routing PCB 104 to reduce the number of connectors (e.g., number of rows+number of columns).

The flexible routing PCB 104 is coupled to the multiplexer assembly 106. The multiplexer assembly 106 may include a column multiplexer 108 and a row multiplexer 110. Individual coil elements 102.1-102.n can be addressed using the column multiplexer 108 and row multiplexer 110. In the example of a 8×8 coil array 102, the column multiplexer 108 may be provided as a 8×1 multiplexer and the row multiplexer 110 may be provided as a 8×1 multiplexer. The column multiplexer 108 may be used to drive respective coil element(s) by providing a drive signal and bias voltage. The bias voltage may flow through the plurality of diodes 104.1-104.n to reduce (or eliminate) leakage current between coils. The bias voltage may allow for a full dynamic range of the drive signal in the forward regions of the plurality of diodes 104.1-104.n. Generation of secondary current loops can be avoided by providing that the column return path follows the row signal path up to the multiplexer assembly 106.

While FIG. 1 shows one coil array 102 for illustration purposes, multiple coil arrays can be provided. For example, four interleaved coil arrays can be provided where each array can be independently operated.

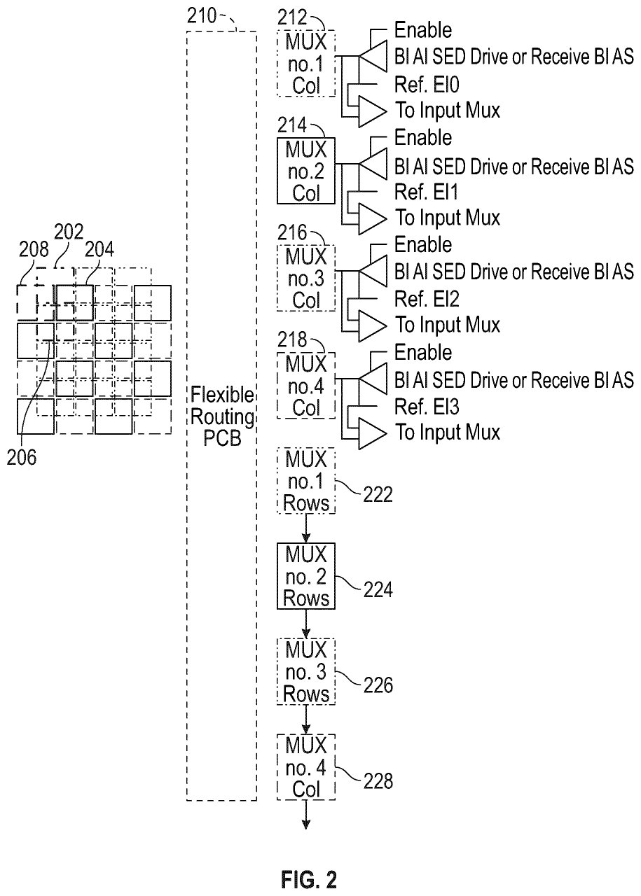

FIG. 2 shows an example of an interleaved RCA ECA probe 200. As shown in FIG. 2, the interleaved RCA ECA probe 200 includes four coil arrays for illustration purposes and other number of coil arrays may be provided. The coil arrays are RCA coil arrays as described herein. Coil elements in the different coil arrays may be provided on the same PCB layers, as described in further detail below. Also, coil elements in respective coil arrays may have an overlapping footprint. In FIG. 2, four coil elements 202-208 are highlighted for illustration purposes.

Coil element 202 may be provided in a first coil array. Coil element 204 may be provided in second coil array. Coil element 206 may be provided in a third coil array. Coil element 208 may be provided in a fourth coil array.

As shown, coil element 202 of the first coil array is provided adjacent to coil element 206 of the third coil array while the footprint coil element 202 overlaps in part with coil element 204 of the second coil array and coil element 208 of the fourth coil array. Coil element 204 of the second coil array is provided adjacent to coil element 208 of the fourth coil array while the footprint of coil element 204 overlaps in part with coil element 202 of the first coil array and coil element 206 of the third coil array. Coil element 206 of the third coil array is provided adjacent to coil element coil element 202 of the first coil array while the footprint of coil element 206 overlaps in part with coil element 204 of the second coil array and coil element 208 of the fourth coil array. Coil element 208 of the fourth coil array is provided adjacent to coil element 204 of the second coil array while the footprint of coil element 208 overlaps in part with coil element 202 of the first coil array and coil element 206 of the third coil array.

The coil arrays are coupled to a flexible routing PCB 210. The flexible routing PCB 210 may include a plurality of diodes corresponding to the coil elements in the coil arrays to block leakage currents, as discussed above.

The flexible routing PCB 210 is coupled a multiplexer assembly including column and row multiplexers for the respective coil arrays. For the first coil array (including coil element 202), a column multiplexer 212 and a row multiplexer 222 may be provided. For the second coil array (including coil element 204), a column multiplexer 214 and a row multiplexer 224 may be provided. For the third coil array (including coil element 206), a column multiplexer 216 and a row multiplexer 226 may be provided. For the fourth coil array (including coil element 208), a column multiplexer 218 and a row multiplexer 228 may be provided. The multiplexer assembly can allow gathering data for multidirectional orthogonal sensors. Each coil element in the respective arrays can be individually controlled using row-column addressing. The respective coil arrays can be configurable in bridge mode (transmit and receive) and receive only mode. For receive-only mode, the bias voltage may be lower.

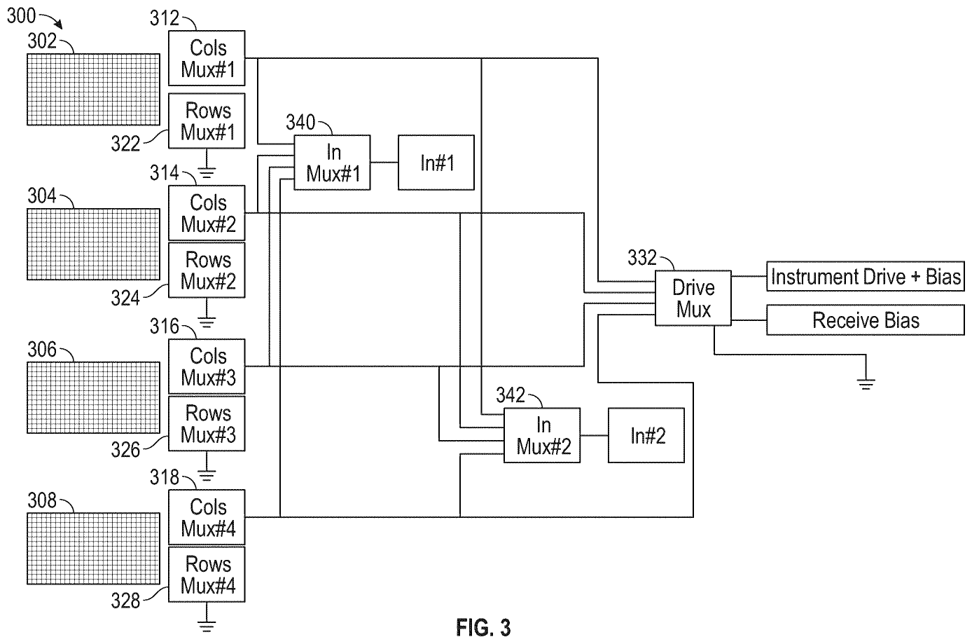

FIG. 3 shows an example of a multi-input RCA ECA probe 300. The multi-input RCA ECA probe 300 includes two inputs providing two sensors in this example for illustration purposes, and other number of inputs may be provided. The multi-input RCA ECA probe 300 may include four coil arrays (RCA coil arrays): coil array 302, coil array 304, coil array 306, and coil array 308. The coil arrays 302-308 may be coupled to a plurality of diodes (not shown) corresponding to the coil elements in the coil arrays to block leakage currents, as discussed above.

The coil elements in the coil arrays 302-308 are individually addressable as an RCA array. Coil array 302 may be coupled to a column multiplexer 312 and a rows multiplexer 322. Coil array 304 may be coupled to a column multiplexer 314 and a rows multiplexer 324. Coil array 306 may be coupled to a column multiplexer 316 and a rows multiplexer 326. Coil array 308 may be coupled to a column multiplexer 318 and a rows multiplexer 328.

The respective column multiplexers can be driven with different signals. Column multiplexers 312, 314, 316, 318 may be coupled to a drive multiplexer 332. The drive multiplexer 332 may drive the respective coil arrays 302-308 into three states: 1) drive+bias, 2) receive bias; 3) ground (to disable the respective coil array).

Two inputs are provided in this example. A first input multiplexer 340 may be coupled to the respective coil arrays 302-308 to provide a first input (IN #1). A second input multiplexer may be coupled to the respective coil arrays 302-308 to provide a second input (IN #2). Hence, the multi-input RCA ECA probe 300 can be configured to provide two configurable sensors at each timeslot.

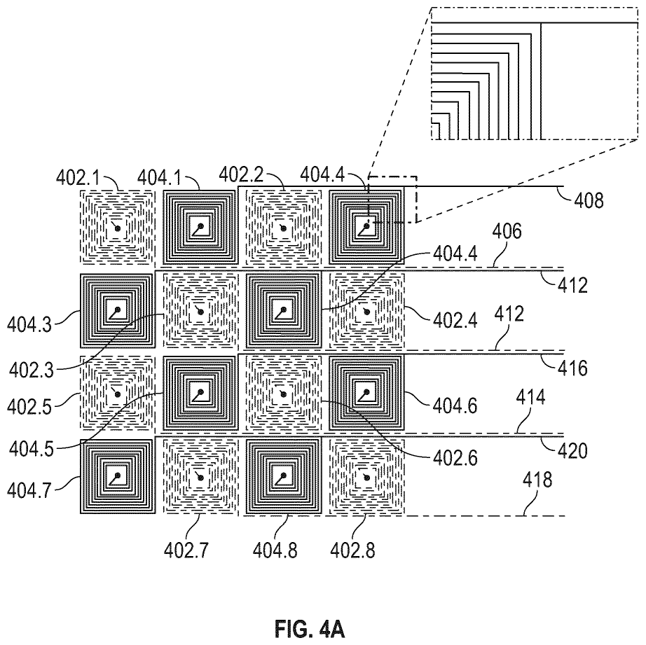

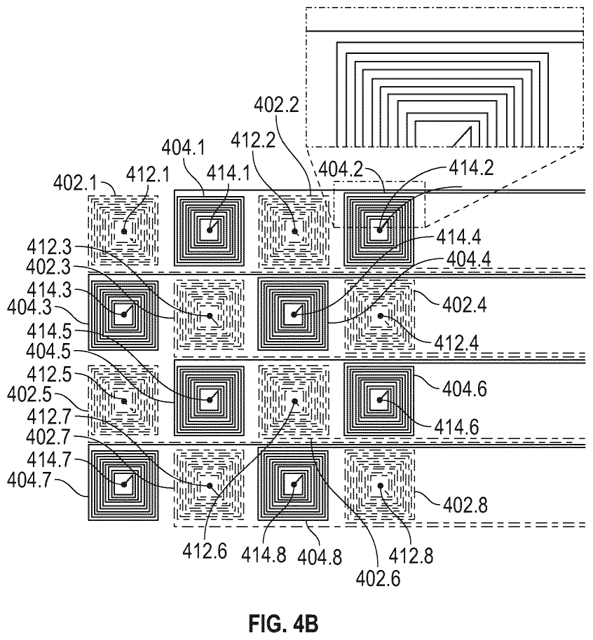

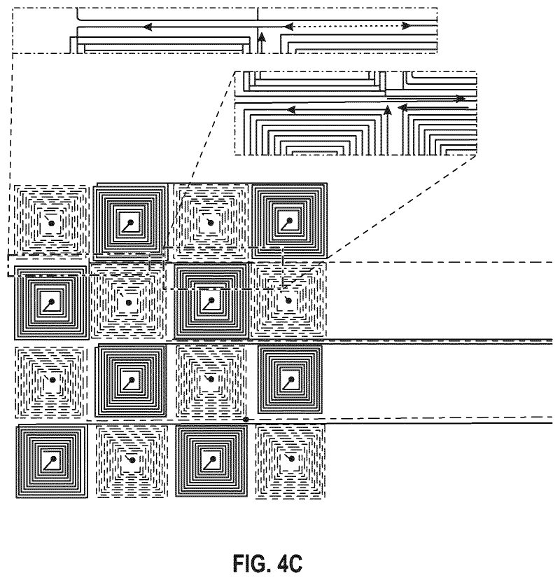

The coil arrays, as described herein, can be interleaved so that multiple coil arrays can share the same PCB layers. FIGS. 4A-4C show example portions of two interleaved coil arrays.

FIG. 4A shows a first PCB layer with coil elements from two coil arrays. Coil elements 402.1-402.8 belong to a first coil array, and coil elements 404.1-404.8 belong to a second coil array. The first PCB layer may be used to provide row addressing. In this example, coil elements in the same row of the same coil array can share a common signal trace for row addressing. With respect to the first coil array, trace 406 is coupled to coil elements 402.1, 402.2; trace 410 is coupled to coil elements 402.3, 402.4; trace 414 is coupled to coil elements 402.5, 402.6; and trace 418 is coupled to coil elements 402.7, 402.8.

With respect to the second coil array, trace 408 is coupled to coil elements 404.1, 404.2; trace 412 is coupled to coil elements 404.3, 404.4; trace 416 is coupled to coil elements 404.5, 404.6; and trace 420 is coupled to coil elements 404.7, 404.8.

FIG. 4B shows a second PCB layer with coil elements from the two coil arrays. Coil elements 402.1-402.8 of the first coil array and coil elements 404.1-404.8 of the second coil array are shown. The second PCB layer may be used for column addressing. In this example, each coil element has its own independent signal trace for column addressing.

Central coil vias 412.1-412.8, 414.1-414.8 connect the first PCB layer and the second PCB. For example, central coil via 412.1 of the first coil element 402.1 of the first array connects the first PCB layer and the second PCB layer, central coil via 414.1 of the first coil element 404.1 of the second array connects the first PCB layer and the second PCB layer, and so on.

FIG. 4C shows a two-layer PCB stack. As shown in FIG. 4C, the first and second coil arrays are interleaved on the two-layer PCB stack. The parallel rows and column addressing traces can be provided in close proximity to reduce noise.

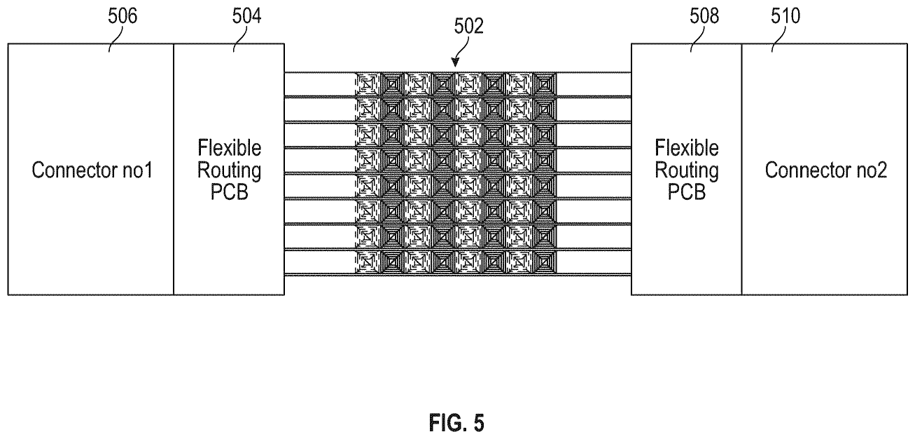

Signals can be routed from the PCB stack from multiple sides to ease PCB routing and to maintain minimal distance between row and column traces. FIG. 5 shows example portions of a RCE ECA probe 500. The RCA ECA probe 500 includes a PCB stack 502. The PCB stack 502 can include a plurality of interleaved coil arrays, such as described above with reference to FIGS. 4A-4C.

A first flexible routing PCB 504 may be provided on one side of the PCB stack 502. The first flexible routing PCB 504 may include a plurality of diodes corresponding to a subset (e.g., half) of the coil elements in the PCB stack 502. A first connector 504 may be coupled to the first flexible routing PCB 504. The first connector 504 may be coupled to a multiplexer assembly (not shown), as described above.

A second flexible routing PCB 508 may be provided on another side of the PCB stack 502. The second flexible routing PCB 508 may include a plurality of diodes corresponding to a subset (e.g., half) of the coil elements in the PCB stack 502. A second connector 510 may be coupled to the second flexible routing PCB 508. The second connector 510 may be coupled to a multiplexer assembly (not shown), as described above.

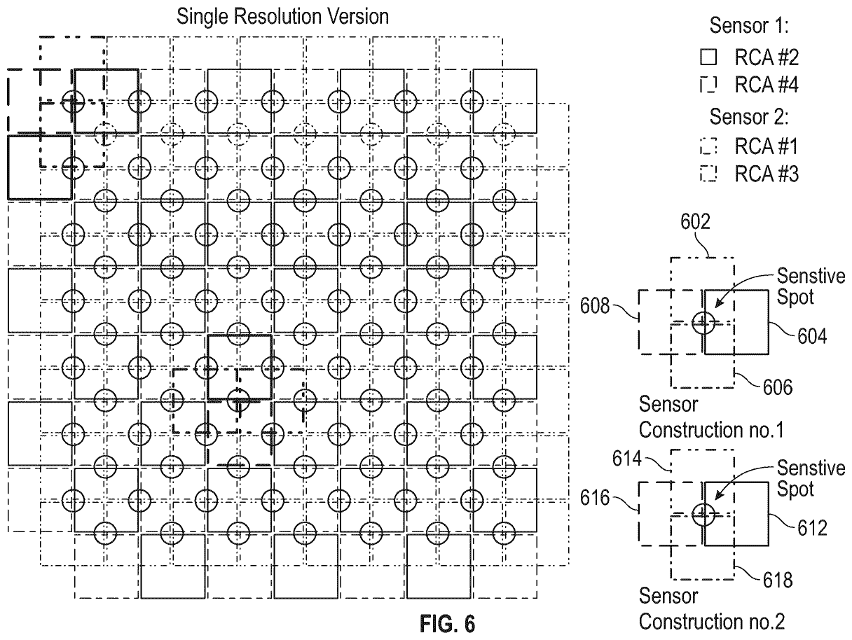

FIG. 6 shows example portions of a composite sensor constructions. A first sensor construction is provided with coil element 602 of the first coil array, coil element 604 of the second coil array, coil element 606 of the third coil array, and coil element 608 of the fourth coil array. A second sensor construction is provided with coil element 612 of the first coil array, coil element 614 of the second coil array, coil element 616 of the third coil array, and coil element 618 of the four-coil array. In some examples, a drive multiplexer may be used to individually energize any of the four coil elements either simultaneously or on different time slots and the four coil elements can also be used in reception. A typical configuration of this four-coil assembly is to use opposite coils in transmission and the other two coils in differential reception to produce a single composite sensor with sensitive spot in the center of the four coil elements. Other techniques may be used to produce composite sensor(s) out of this coil assembly such as transmitting alternatively on each of the four-coil element and, for each transmission coil selection acquiring receiving signals on each of the four coil elements in order to capture the full interaction matrix between the four coil elements. Once the full interaction matrix is obtained, any sensor configuration involving the four coil elements can be obtained through signal processing.

RCA ECA probes, as described herein, may be provided in different resolutions. FIG. 6 shows example portions of coil arrays in a single resolution probe 600. The single resolution probe 600 can include four coil arrays with two coil arrays sharing a two-layer PCB stack. Hence, the single resolution probe 600 may include a first two-layer PCB stack (e.g., as shown in FIGS. 4A-4C) for a first and second coil array, and the single resolution probe 600 may include a second two-layer PCB stack (e.g., as shown in FIGS. 4A-4C) for a third and fourth coil array. The combined sensitive areas may have sufficient overlap between the coil elements to ensure good coverage within the probe.

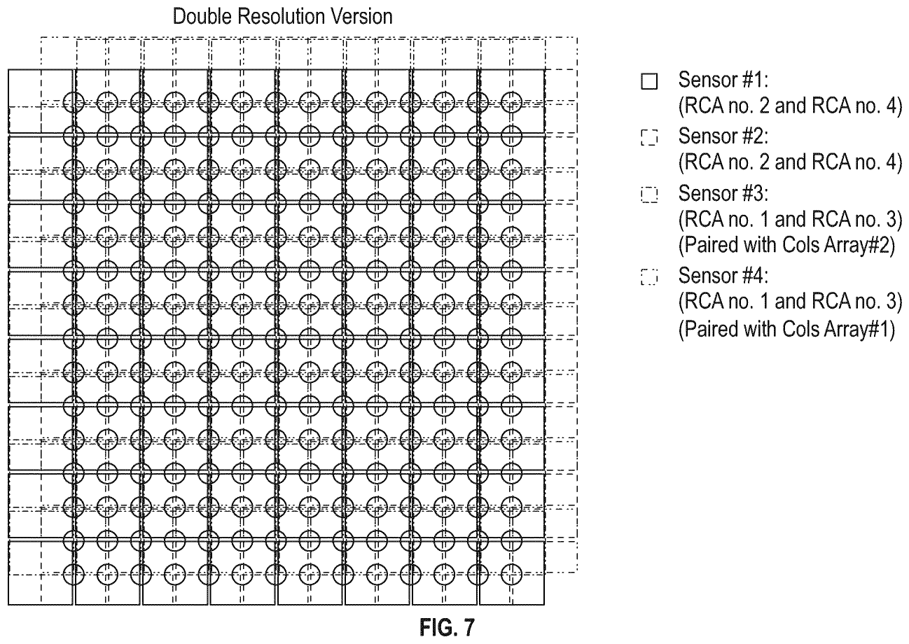

Some flaws, such as short flaws, may be better suited for detection by a double resolution probe. FIG. 7 shows example portions of coil arrays in a double resolution probe 700. The double resolution probe 700 may be provided on eight PCB layers and four PCB stack. The double resolution probe 700 may include four coil arrays distributed on four PCB stack. A first coil array may be provided using coil components on a first PCB stack and second PCB stack. A second coil array may be provided using coil components on a first PCB stack and second PCB stack. A third coil array may be provided using coil elements on a third PCB stack and a fourth PCB stack. A fourth coil array may be provided using coil elements on a third PCB stack 826 and a fourth PCB stack.

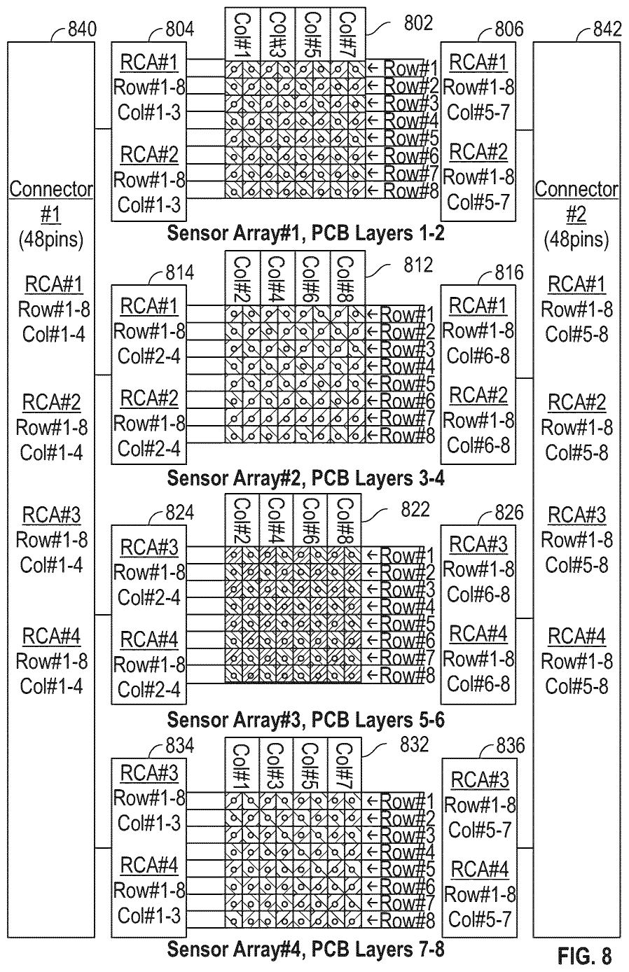

FIG. 8 shows example portions of array addressing of a double resolution sensor. A first sensor array 802 may be provided on a first and second PCB layers, which include coil connections for a first coil array (RCA #1) and second coil array (RCA #2), each coil array being an 8×8 array in this example.

As shown, the first sensor array 802 includes rows 1-8 and columns 1, 3, 5, and 7 of the first coil array and second coil array. A first set of traces 804 may be provided on one side of the first sensor array 802 for rows 1-8 and columns 1 and 3. A second set of traces 806 maybe provided on a second side of the first sensor array 802 for rows 1-8 and columns 5 and 7.

A second sensor array 812 may be provided on a third and fourth PCB layers, which include coil connections for the first coil array (RCA #1) and second coil array (RCA #2). The second sensor array 812 includes rows 1-8 and columns 2, 4, 6, and 8 of the first coil array and second coil array. A first set of traces 814 may be provided on one side of the second sensor array 812 for rows 1-8 and columns 2 and 4. A second set of traces 816 may be provided on a second side of the second sensor array 812 for rows 1-8 and columns 6 and 8.

A third sensor array 824 may be provided on a fifth and sixth PCB layers, which include coil connections for a third coil array (RCA #3) and fourth coil array (RCA #4). The third sensor array 822 includes rows 1-8 and columns 2, 4, 6, and 8 of the third coil array and fourth coil array. A first set of traces 824 may be provided on one side of the third sensor array 822 for rows 1-8 and columns 2 and 4. A second set of traces 826 may be provided on a second side of the third sensor array 812 for rows 1-8 and columns 6 and 8.

A fourth sensor array 832 may be provided on a seventh and eighth PCB layers, which include coil connections for the third coil array (RCA #3) and fourth coil array (RCA #4). As shown, the fourth sensor array 832 includes rows 1-8 and columns 1, 3, 5, and 7 of the third coil array and fourth coil array. A first set of traces 804 may be provided on one side of the fourth sensor array 832 for rows 1-8 and columns 1 and 3. A second set of traces 836 maybe provided on a second side of the fourth sensor array 832 for rows 1-8 and columns 5 and 7.

In this example, the overlapping sensor arrays 802, 812, 822, 832 can share the same coil array connection because the first and second coil arrays may not be activated simultaneously. Hence, even with a double resolution array, only four independent interleaved coil arrays can be used in this example.

Processing (e.g., executing one or more of the methods described herein) may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information. The memory may include a machine readable medium on which is stored one or more sets of data structures or instructions (e.g., software) embodying or utilized by any one or more of the techniques or functions described herein.

In some embodiments, the system may be embodied by one or more programmable processors executing one or more computer programs to perform the functions of the system. In some other embodiments, all or part of the system may be implemented as special purpose logic circuitry (e.g., a field-programmable gate array (FPGA) and/or an application-specific integrated circuit (ASIC)). In some other embodiments, all or part of the system may be implemented using electronic hardware circuitry that include electronic devices such as, for example, at least one of a processor, a memory, a programmable logic device or a logic gate.

In one embodiment, the methods described herein are not limited to the specific examples described. In a further embodiment, rather, any of the method steps may be re-ordered, combined or removed, or performed in parallel or in serial, as necessary, to achieve the results set forth above.

In some embodiments, the system may be implemented, at least in part, via a computer program product, (e.g., in a non-transitory machine-readable storage medium such as, for example, a non-transitory computer-readable medium), for execution by, or to control the operation of, data processing apparatus (e.g., a programmable processor, a computer, or multiple computers)). In certain embodiments, each such program may be implemented in a high level procedural or object-oriented programming language to communicate with a computer system. In certain other embodiments, however, the programs may be implemented in assembly or machine language. In some embodiments, the language may be a compiled or an interpreted language and it may be deployed in any form, including as a stand-alone program or as a module, component, subroutine, or other unit suitable for use in a computing environment. In some other embodiments, a computer program may be deployed to be executed on one computer or on multiple computers at one site or distributed across multiple sites and interconnected by a communication network.

The methods and apparatus of this disclosure may take the form, at least partially, of program code (i.e., instructions) embodied in tangible non-transitory media, such as floppy diskettes, CD-ROMs, hard drives, random access or read only-memory, or any other machine-readable storage medium.

When the program code is loaded into and executed by a machine, such as the computer of FIG. 4, the machine becomes an apparatus for practicing examples of the present subject matter. When implemented on one or more general-purpose processors, the program code combines with such a processor to provide a unique apparatus that operates analogously to specific logic circuits. As such, a general purpose digital machine can be transformed into a special purpose digital machine. In some other embodiment, a non-transitory machine-readable medium may include but is not limited to a hard drive, compact disc, flash memory, non-volatile memory, volatile memory, magnetic diskette and so forth but does not include a transitory signal per se.

The term “machine readable medium” or “machine readable storage medium” may include any medium that is capable of storing, encoding, or carrying instructions for execution by a machine and that cause the machine to perform any one or more of the techniques of the present disclosure, or that is capable of storing, encoding or carrying data structures used by or associated with such instructions. Non-limiting machine-readable medium examples may include solid-state memories, and optical and magnetic media. Accordingly, machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic or other phase-change or state-change memory circuits; magnetic disks, such as internal hard disks and removable disks; magneto-optical disks; and CD-ROM and DVD-ROM disks.

Although the foregoing examples have been described in some detail for purposes of clarity of understanding, it will be apparent that certain changes and modifications may be practiced within the scope of the appended claims. The scope of the invention is limited only by the claims and the invention encompasses numerous alternatives, modifications, and equivalents. Numerous specific details are set forth in the above description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured. Accordingly, the above implementations are to be considered as illustrative and not restrictive, and the invention is not to be limited to the details given herein, but may be modified within the scope and equivalents of the appended claims.

Various embodiments of the present disclosure have been described with reference to the accompanying drawings. It may be appreciated that these example embodiments are provided only for enabling those skilled in the art to better understand and then further implement the present disclosure and not intended to limit the scope of the present disclosure in any manner. It should be noted that these drawings and description are only presented as examples of embodiments and, based on this description, alternative embodiments may be conceived that may have a structure and method disclosed as herein, and such alternative embodiments may be used without departing from the principle of the disclosure as claimed in the present disclosure.

It may be noted that the flowcharts and block diagrams in the figures may illustrate the apparatus, method, as well as architecture, functions and operations executable by a computer program product according to various embodiments of the present disclosure. In this regard, each block in the flowcharts or block diagrams may represent a module, a program segment, or a part of code, which may contain one or more executable instructions for performing specified logic functions. It should be further noted that, in some alternative implementations, functions indicated in blocks may occur in an order differing from the order as illustrated in the figures. For example, two blocks shown consecutively may be performed in parallel substantially or in an inverse order sometimes, which depends on the functions involved. It should be further noted that each block and a combination of blocks in the block diagrams or flowcharts may be implemented by a dedicated, hardware-based system for performing specified functions or operations or by a combination of dedicated hardware and computer instructions.

The terms “comprise(s),” “include(s)”, their derivatives, and like expressions used herein should be understood to be open (i.e., “comprising/including, but not limited to”). The term “based on” means “at least in part based on”, the term “one embodiment” means “at least one embodiment”, and the term “another embodiment” indicates “at least one further embodiment”. Relevant definitions of other terms have been provided.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like.

Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other implementations can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed implementation. Thus, the following claims are hereby incorporated into the Detailed Description as examples or implementations, with each claim standing on its own as a separate implementation, and it is contemplated that such implementations can be combined with each other in various combinations or permutations. The scope of the invention should be determined with reference to the appended claims, along with the full scope of equivalents to which such claims are entitled.

1-20. (canceled)

21. A row-column addressed (RCA) eddy current array (ECA) probe, comprising:
at least one coil array including a plurality of coil elements;
a diode array including a plurality of diodes coupled to the plurality of coil elements; and
a multiplexer assembly for row and column addressing of the plurality of coil elements.

22. The RCA ECA probe of claim 21, wherein the diode array is provided on a flexible printed circuit board (PCB) coupled to the at least one coil array.

23. The RCA ECA probe of claim 21, wherein a first portion of the diode array is provided on a first flexible printed circuit board (PCB) coupled to a first side of the at least one coil array, and wherein a second portion of the diode array is provided on a second flexible PCB coupled to a second side of the at least one coil array.

24. The RCA ECA probe of claim 21, wherein at least one diode of the plurality of diodes is coupled in series with at least one coil element of the plurality of coil elements.

25. The RCA ECA probe of claim 21, wherein the multiplexer assembly is configured to drive a column multiplexer with a drive signal and bias signal in transmission mode, wherein at least one diode of the plurality of diodes is configured to operate in a forward region based on the bias signal.

26. The RCA ECA probe of claim 21, wherein the at least one coil array includes a first coil array and a second coil array interleaved on a first layer of a PCB and a second layer of the PCB.

27. The RCA ECA probe of claim 26, wherein the first layer includes signal traces for row addressing for coil elements of the first coil array and the second coil array.

28. The RCA ECA probe of claim 27, wherein at least two coil elements of the first coil array in a same row use a common signal trace for row addressing.

29. The RCA ECA probe of claim 26, wherein the second layer includes signal traces for column addressing for coil elements of the first coil array and the second coil array.

30. The RCA ECA probe of claim 21, wherein the at least one coil array includes a first coil element and a second coil element, and wherein a first footprint of the first coil element at least partially overlaps with a second footprint of the second coil element.

31. The RCA ECA probe of claim 21, wherein the at least one coil array includes four coil arrays.

32. A method comprising:
activating a first set of coil elements in a row-column addressed (RCA) eddy current array (ECA) using a drive signal and a bias signal, wherein the bias signal operating at least one diode coupled to the first set of coil elements in a forward region; and
receiving an electrical representation of an induced eddy current using the RCA ECA.

33. The method of claim 32, wherein the at least diode is provided on a flexible printed circuit board (PCB) coupled to the first set of coil elements.

34. The method of claim 32, wherein the first set of coil elements are provided in a first sensor configuration, and the method further comprising:
activating a second set of coil elements in a second sensor configuration.

35. The method of claim 32, wherein the at least diode is coupled to a coil element of the first set of coil elements in series.

36. The method of claim 32, further comprising:
connecting a second set of coil elements in the RCA ECA to ground.

37. The method of claim 32, wherein the first set of coil elements are provided in a first coil array and a second coil array interleaved on a first layer of a PCB and a second layer of the PCB.

38. The method of claim 37, wherein the first layer includes signal traces for row addressing for coil elements of the first coil array and the second coil array,
wherein at least two coil elements of the first coil array in a same row use a common signal trace for row addressing.

39. A probe assembly for eddy current testing, the probe assembly comprising:
a first layer of a printed circuit board including a first set of metallic traces for interleaved coil elements of a first coil array and a second coil array;
a second layer of the printed circuit board including a second set of metallic traces for the interleaved coil elements of the first coil array and the second coil array; and
a diode array coupled to the interleaved coil elements of the first coil array and the second coil array.

40. The probe assembly of claim 39, wherein diode array is provided on a flexible printed circuit board coupled to the printed circuit board.
